(19) United States
(12) Patent Application Publication
(10) Pub. No.: US 2010/0230849 A1
(43) Pub. Date: Sep. 16, 2010

(54) CUTTER

(75) Inventors: JUN-LIANG MIAO, Shenzhen City (CN); ZHI-QIANG CHEN, Shenzhen City (CN); SHAO-FENG CAI, Shenzhen City (CN); WEI ZHAO, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/479,926

(22) Filed: Jun. 8, 2009

(30) Foreign Application Priority Data
Mar. 13, 2009 (CN) 200910300834.3

(51) Int. Cl. B29C 45/38; B26D 3/00

(52) U.S. Cl. 264/161; 425/389; 407/113

(57) ABSTRACT

A cutter includes a contacting surface and a stopping surface opposite to the contacting surface. A distal end of the cutter defines a cutting groove through the contacting surface and the stopping surface, forming two opposite resisting blocks. The resisting blocks are located on both sides of the cutting groove. A molding assembly is also provided.

### BACKGROUND

1. Technical Field

The present disclosure relates to cutters and, particularly, to a cutter used in insert-molding.

2. Description of Related Art

Many electronic elements are manufactured by insert-molding. Insert-molding is a method that injects hot-melted plastic into a molding chamber to form an electronic element via a hot-runner. The hot-runner communicates with the molding chamber via a channel. When the molding chamber is cooled, a connecting head is usually formed in the channel, connected to the product, i.e., the electronic element. Thus, a cutter has to be used to sever the connecting head from the product.

A typical cutter has a wedge head portion. The head portion forms its cutting chin at a front. To sever a connecting head, the cutter is mounted in a thimble hole of a male mold of the molding assembly and driven to move towards a female mold along the thimble hole by the insert-molding machine. Thus, the cutting chin of the cutter can sever the connecting head along the connecting portion between the connecting head and the product.

However, the cutter may be extruded towards the product and further hit the female mold during the cutting process, which not only destroys the cutter, but also make the connecting portion have a burr.

Therefore, there is room for improvement within the art.

### BRIEF DESCRIPTION OF THE DRAWINGS

Many aspects of the cutter can be better understood with reference to the following drawings. These drawings are not necessarily drawn to scale, the emphasis instead being placed upon clearly illustrating the principles of the present cutter. Moreover, in the drawings like reference numerals designate corresponding sections throughout the several views.

FIG. 1 is an isometric view of a cutter, in accordance with an exemplary embodiment.

FIG. 2 is a schematic figure showing the cutter shown in FIG. 1 mounted to a molding assembly.

FIG. 3 is a cross-sectional view of a molding assembly incorporated with the cutter shown in FIG. 2, taken along line III-III.

FIG. 4 is a cross-sectional view of a molding assembly shown in FIG. 4.

FIG. 5 is a schematic figure showing the cutting process of the cutter shown in FIG. 3.

FIG. 6 is a cross-sectional view of a molding assembly incorporated with the cutter shown in FIG. 4, taken along line VI-VI.

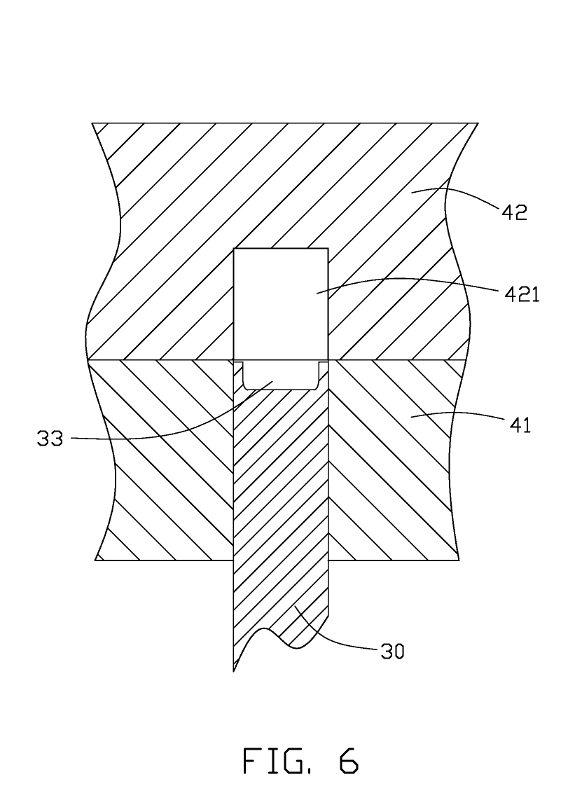

### DETAILED DESCRIPTION

The present cutter is suitable for use in severing a connecting head in insert-molding.

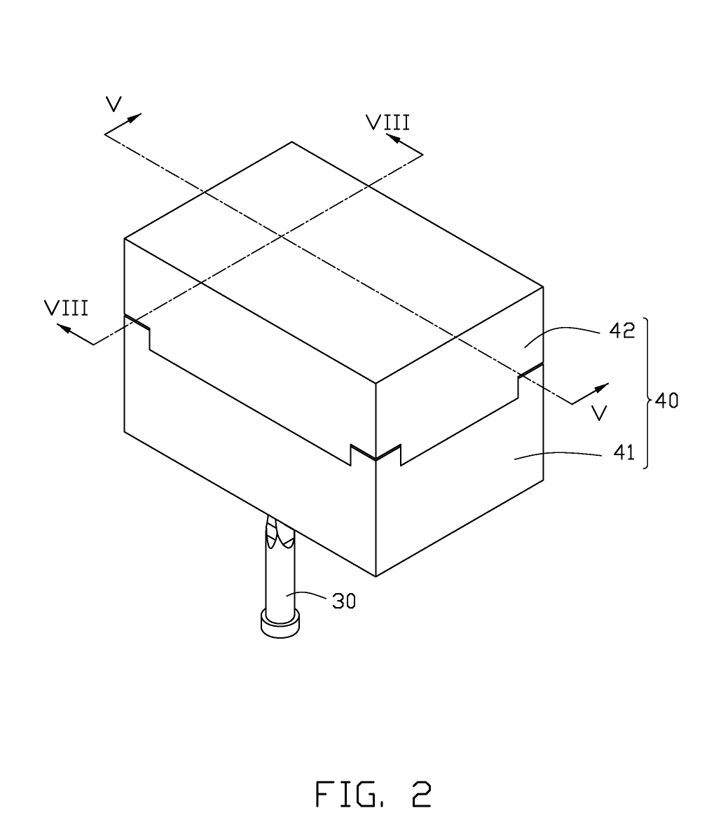

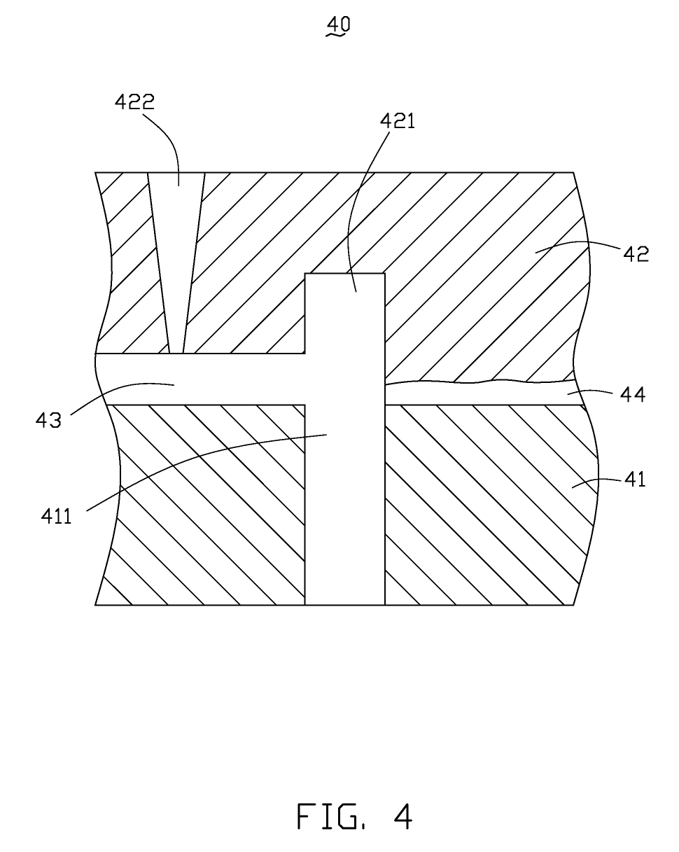

Referring to FIGS. 2 and 4, a molding assembly 40 includes a male mold 41 and a female mold 42. The male mold 41 defines a thimble hole 411. The female mold defines a receiving hole 421 corresponding to the thimble hole 411. After assembly together, the male mold 41 and the female mold 42 enclose a channel 43 and a molding chamber 44 therebetween. The female mold 42 further defines a hot-runner 422 communicating with the channel 43, so that the hot-melted plastic is injected into the molding chamber 44 through the hot-runner 422 and the channel 43. The thimble hole 411 and the receiving hole 421 are coaxial, located between the channel 43 and the molding chamber 44, and communicate with the channel 43 and the molding chamber 44.

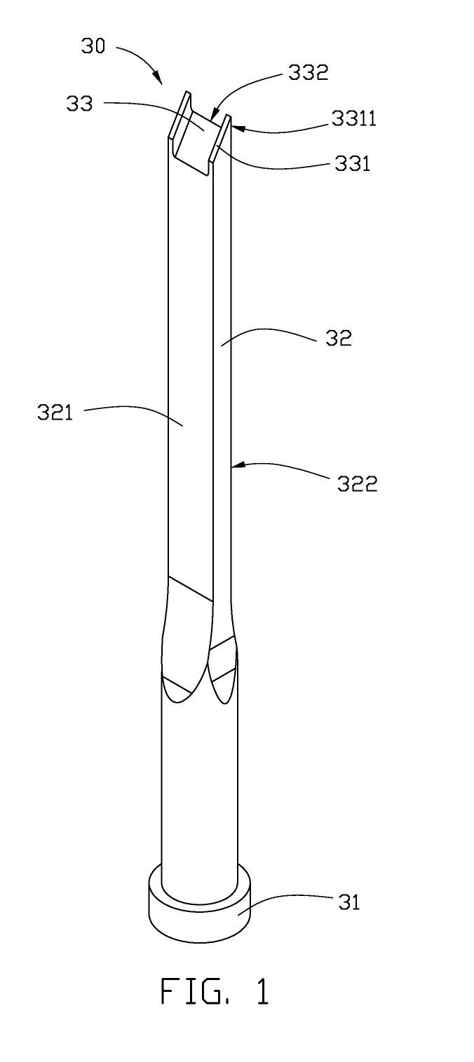

Referring to FIG. 1, the present exemplary embodiment cutter 30 includes a head portion 31 and a cutting portion 32 connected to the head portion 31. The head portion 31 is fixed to an insert-molding machine. The cutting portion 32 includes a contacting surface 321 and a stopping surface 322 opposite to the contacting surface 321. A distal end of the cutting portion 32 opposite to the head portion 31 includes two opposite resisting blocks 331. Resisting blocks 331 define boundaries of a cutting groove 33 through the contacting surface 321 and the stopping surface 322. The cutting groove 33 forms a cutting chin 332 on the stopping surface 322. Each resisting block 331 has a resisting surface 3311 adjacent to the cutting chin 332. The cutter 30 is mounted in the thimble hole 411, with the stopping surface 322 facing the molding chamber 44 and the cutting groove 33 communicating with the channel 43 and the molding chamber 44. Thus, the resisting blocks 331 are partially received in the receiving hole 421, and the resisting surface 3311 abuts against an interior wall of the receiving hole 421 of the female mold 42.

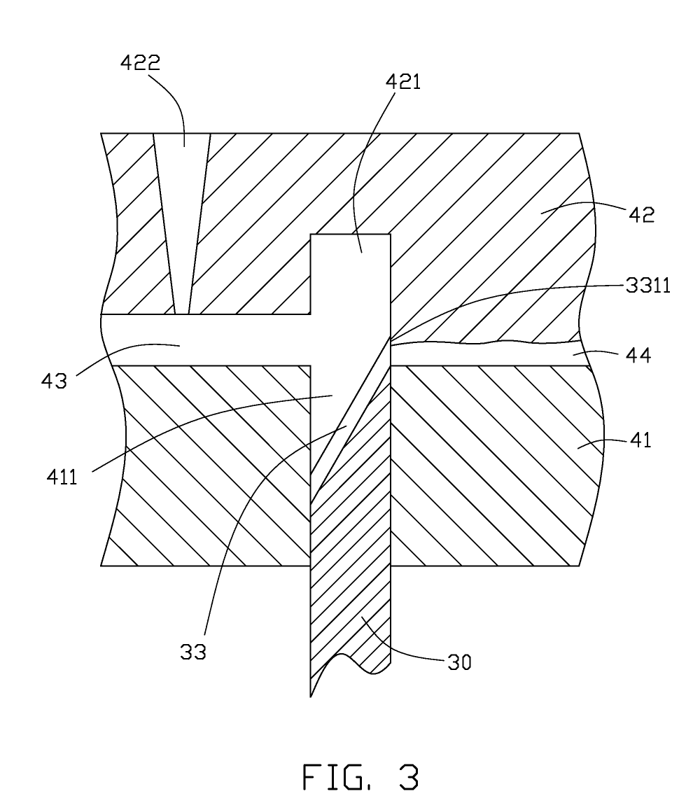

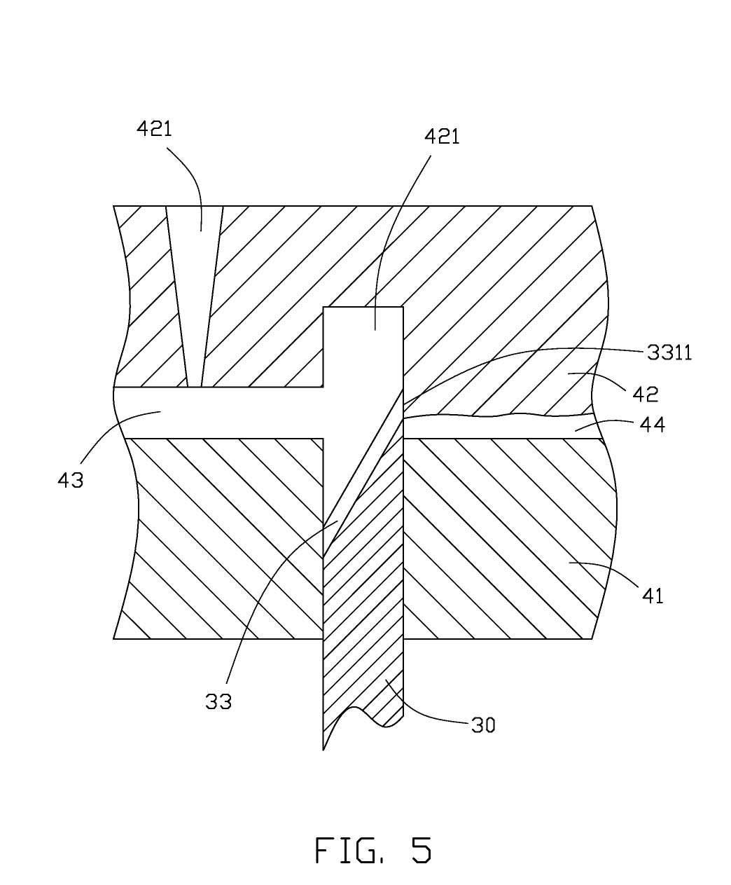

Referring to FIGS. 3 and 5, when needing to sever a connecting head formed in the channel 43 from a product formed in the molding chamber 44 along the connecting portion between the connecting head and the product, the cutter 30 is triggered to move from the thimble hole 411 towards the receiving hole 421. During cutting process, although the cutter 30 is also pressed by the connecting head towards the molding chamber 44, the resisting surface 3311 abuts against the interior surface of the receiving hole 421, which can prevent the cutting chin 332 from contacting/damaging the product formed in the molding chamber 44. Thus, hits between the cutter 30 and the female mold 42 can be avoided, which effectively protects the cutter 30 and avoids burrs on the product.

It is to be understood, however, that even through numerous characteristics and advantages of the present disclosure have been set forth in the foregoing description, together with details of the structure and function of the disclosure, the disclosure is illustrative only, and changes may be made in detail, especially in matters of shape, size, and arrangement of sections within the principles of the disclosure to the full extent indicated by the broad general meaning of the terms, in which the appended claims are expressed.

What is claimed is:

1. A cutter comprising:
a head portion including a contacting surface and a stopping surface opposite to the contacting surface;
wherein a distal end of the cutter includes two opposite resisting blocks defining a cutting groove through the contacting surface and the stopping surface.

2. The cutter as claimed in claim 1, wherein the cutting groove forms a cutting chin on the stopping surface and the resisting blocks have a resisting surface adjacent to the cutting chin.

3. A molding assembly having a cutter comprising:
a male mold defining a thimble hole; and
a female mold defining a receiving hole corresponding to the thimble hole, after assembly together, the male mold and the female mold enclose a channel and a molding chamber communicating with the channel;
the cutter being mounted in the thimble hole, the cutter including a contacting surface and a stopping surface;
wherein the cutter includes two opposite resisting blocks defining a cutting groove through the contacting surface and the stopping surface, the cutting groove communicating with the channel and the chamber.

4. The molding assembly as claimed in claim 3, wherein the thimble hole and the receiving hole are coaxial and located between the channel and the molding chamber, and the cutter can advance along the thimble hole to the receiving hole.

5. The molding assembly as claimed in claim 4, wherein the resisting blocks are received in the receiving hole of the female mold, and the resisting blocks abut against an interior wall of the receiving hole.

6. A molding method comprising the following steps:
providing a molding assembly, the molding assembly including a male mold and a female mold, the male mold defining a thimble hole, the female defining a receiving hole;
assembling the male mold and the female mold together, the male mold and the female mold forming a channel and a molding chamber communicating with the channel;
providing a cutter, the cutter including a contacting surface and an opposite stopping surface, the cutter including two opposite resisting blocks defining a cutting groove through the contacting surface and the stopping surface;
mounting the cutter in the thimble hole, with the cutting groove communicating the channel and the molding chamber, the resisting blocks abutting against an interior wall of the receiving hole;
injecting hot-melted plastic into the molding chamber to form a product and a connecting head connected to the product;
moving the cutter along the thimble hole to the receiving hole, thereby severing the connecting head from the product.
